(19) United States
(12) Patent Application Publication
(10) Pub. No.: US 2010/0164304 A1
(43) Pub. Date: Jul. 1, 2010

(54) Base for Planar Servo Motor

(76) Inventor: Chien-Cheng LIN, Taichung (TW)

Correspondence Address: Dr. BANGER SHIA;Patent Office of Bang Shia, 102 Lindencrest Ct., Sugar Land, TX, 77479-5201, US

(21) Appl. No.: 12/345,628

(22) Filed: Dec. 29, 2008

(51) Int. Cl. H02K 41/02

(52) U.S. Cl. 310/12.01

(57) ABSTRACT

A base for planar servo motor which is defined with a hollow space for reducing the weight of the base. Thereby, when the base is hung upside down, the base can be prevented from being deformed by its own weight, and the load of a machine table for supporting the base can be relatively reduced, so as to avoid causing vibration of the machine table. In addition, the hollow space can reduce the material for manufacturing the base, so that the cost is reduced.

### BACKGROUND OF THE INVENTION

1. Field of the Invention

The present invention relates to a base for planar servo motor concerning electric machinery, and more particularly to a base for planar servo motor which comprises a stator, a mover and a hollow space that can reduce the weight of the base, avoid causing deformation of the base and vibration of the machine table.

2. Description of the Prior Art

Motors are widely used in our daily life for accomplishing many works, therefore, various kinds of motors being developed for meeting different working requirements. A conventional planar servo motor 10 as shown in FIG. 1, which is widely applied to precision processing systems, such as, wafer probing, laser cutting or image detecting system, due to the advantages of high speed, high precision, high stability and low maintenance rate. Such a planar servo motor 10 comprises a stator 11 and a mover 12. The stator 11 is provided with magnets, and the mover 12 is provided with coils. The mover 12 will be movable with respect to the stator 11 after being powered on, and the movement of the mover 12 is caused by the magnetic change of the stator 11. However, the conventional stator 11 comprises a base 111 and a panel 112 that is provided on the base 111. In order to maintain the rigidity of the stator 11, the base 111 is made of cast iron or granite, and the panel 112 is made of sheet material with low carbon content. In addition, the base 111 and the panel 112 are usually assembled together by screws or by adhesive. However, using screws to bond them together will increase the manufacturing time, and using adhesive will cause cleaning problem, and even worse, the bonding strength between the base 111 and the panel 112 will probably low due to insufficient adhesive applied. Moreover, since the base 111 is solid and made of cast iron or granite, the weight of the base 111 is very heavy. Thereby, when the planar servo motor 10 is assembled to a machine table and hung upside down, the base 111 is likely to be deformed due to its heavy weight, and even worse, it might cause too great load to the machine table so as to make the machine table vibrate during the working process. As a result, the processing precision will be influenced. In order to solve the above-mentioned problems, the load capacity of the machine table must be improved, so that the cost is increased.

The present invention has arisen to mitigate and/or obviate the afore-described disadvantages.

### SUMMARY OF THE INVENTION

The primary objective of the present invention is to provide a base for planar servo motor which is defined with a hollow space for reducing the weight of the base, avoiding deformation of the base, reducing the load of a machine table and relatively reducing the cost.

To achieve the objective of the present invention, the base for planar servo motor is connected to a panel, and a mover is movable with respect to the panel. The base is closed in cross section and comprises a plurality of lateral surfaces which define a hollow space. The panel is connected to one surface of the base. The hollow space can reduce the weight of the base, so that when the base is hung upside down, the base can be prevented from being deformed by its own weight, and the load of the machine table for supporting the base can be relatively reduced, so as to avoid causing vibration of the machine table. In addition, the hollow space can reduce the material for manufacturing the base, so that the cost is reduced.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is a perspective view of a conventional planar servo motor;

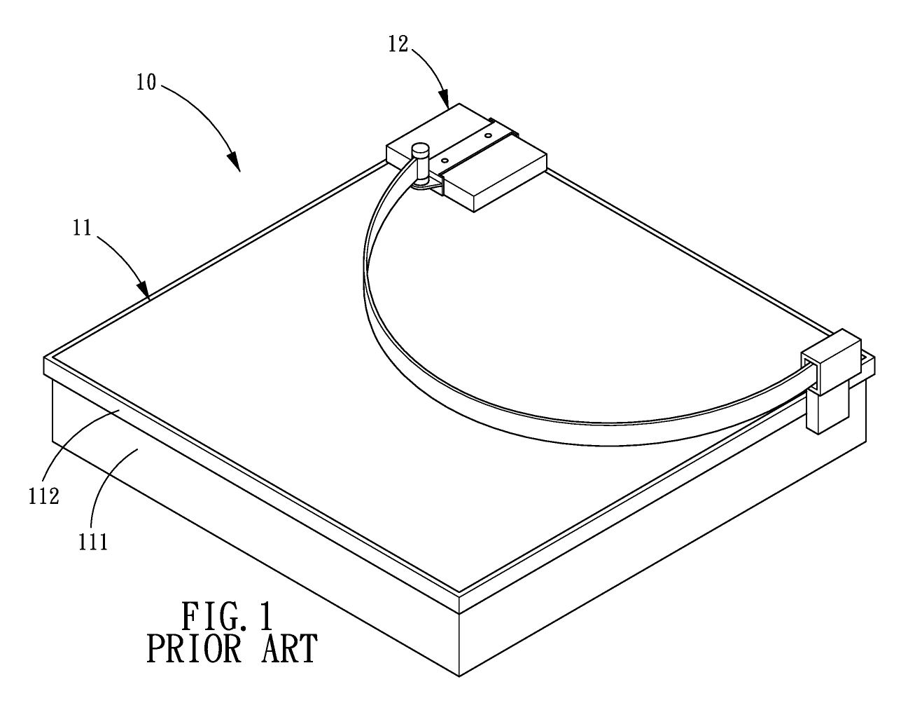

FIG. 2 is a cross sectional view of a base for planar servo motor in accordance with a first embodiment of the present invention;

FIG. 3 is a cross sectional view of the base for planar servo motor in accordance with a second embodiment of the present invention;

FIG. 4 is a cross sectional view of the base for planar servo motor in accordance with a third embodiment of the present invention; and

FIG. 5 is a perspective view of the base for planar servo motor in accordance with the present invention.

### DETAILED DESCRIPTION OF THE PREFERRED EMBODIMENTS

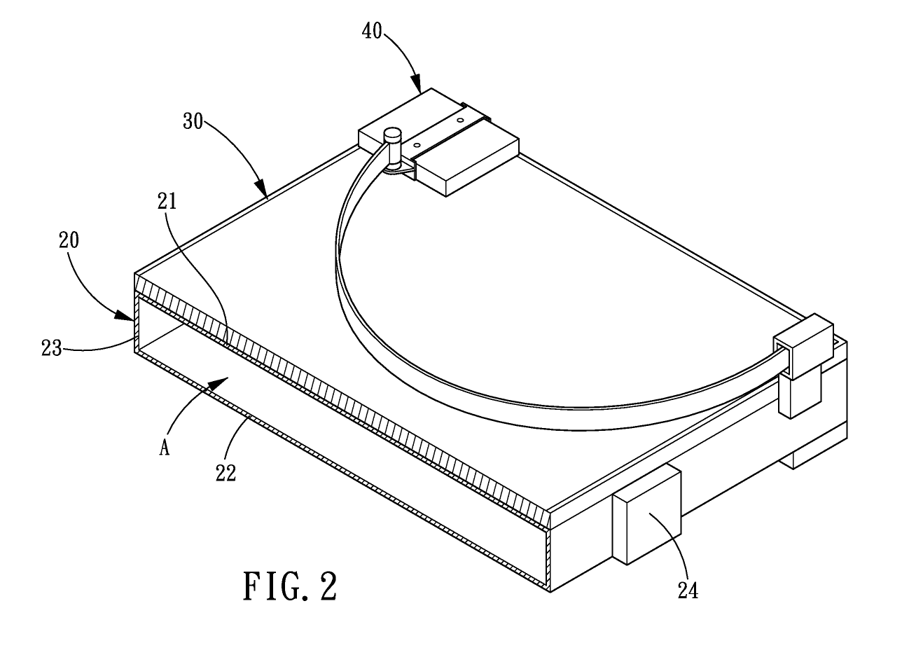

Referring to FIGS. 2-4, a base 20 for planar servo motor in accordance with the present invention is shown, one surface of the base 20 is connected to a panel 30, and a mover 40 is movable with respect to the panel 30.

Referring to FIG. 2, the base 20 in accordance with a first embodiment of the present invention is made of metal and is closed in cross section (in the form of a rectangular shape in this embodiment). The base 20 comprises a working surface 21 and a jointing surface 22 that are located opposite to each other. Between peripheries of the working surface 21 and the jointing surface 22 is provided two lateral surfaces 23. Thereby, a hollow space A is formed in the base 20. The panel 30 is located on top edges of the lateral surfaces 23 and is welded to the working surface 21 of the base 20. On the jointing surface 22 and the lateral surfaces 23 is provided a plurality of assembly portions 24 for assembling the base 20 to a machine table.

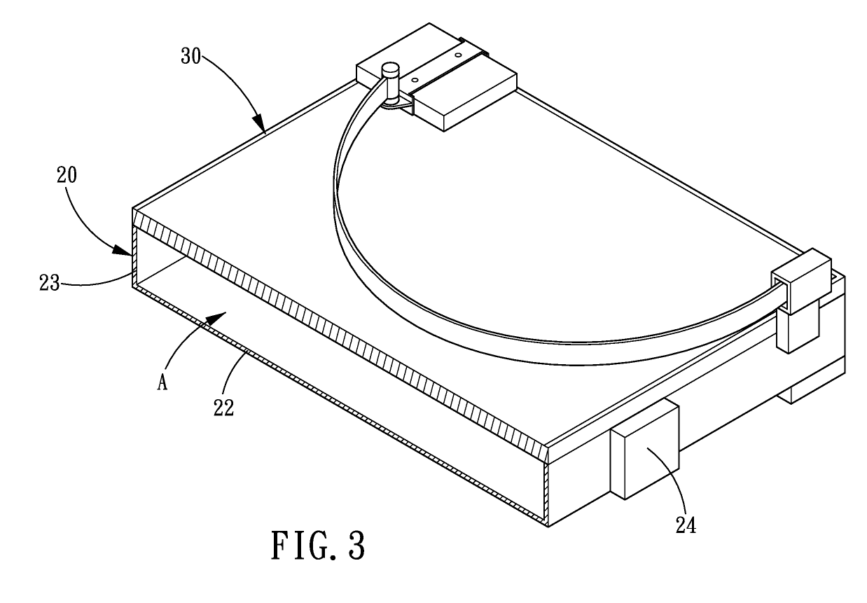

Referring to FIG. 3, the base 20 in accordance with a second embodiment of the present invention comprises a jointing surface 22 and two lateral surfaces 23 and is U-shaped in cross section. The lateral surfaces 23 are connected to the periphery of the jointing surface 22. Thereby, the hollow space A is formed in the base 20. The panel 30 is located on the top edges of the lateral surfaces 23 and is located adjacent to the hollow space A to close the top of the base 20. On the jointing surface 22 and the lateral surfaces 23 is provided a plurality of assembly portions 24 for assembling the base 20 to the machine table.

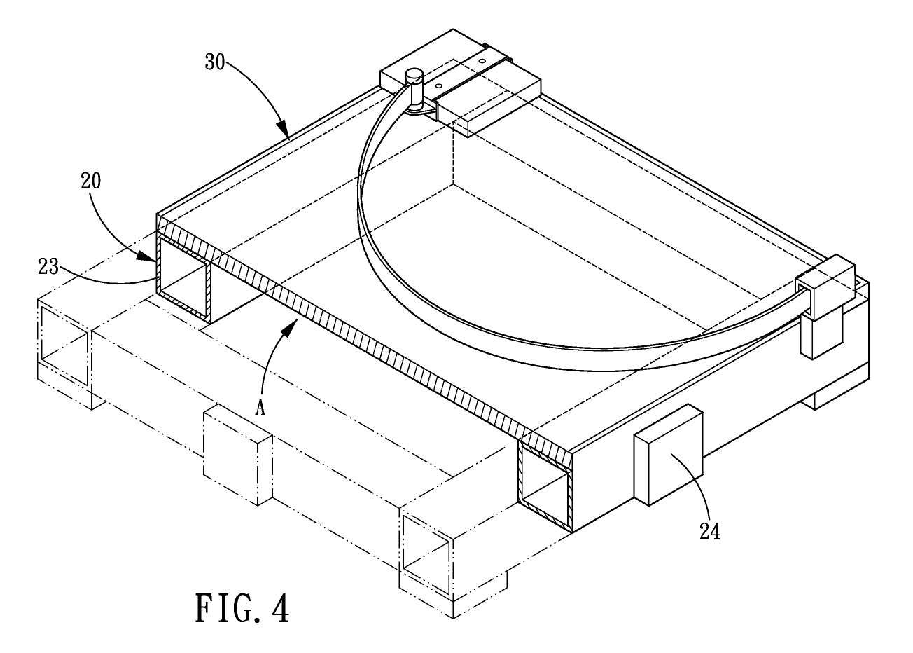

Referring to FIG. 4, the base 20 in accordance with a third embodiment of the present invention comprises four hollow columnar members 26 which are metal pipes arranged in a rectangular array to define the hollow space A and are welded to the panel 30. On the hollow columnar members 26 of the base 20 is provided a plurality of assembly portions 24 for assembling the base 20 to the machine table.

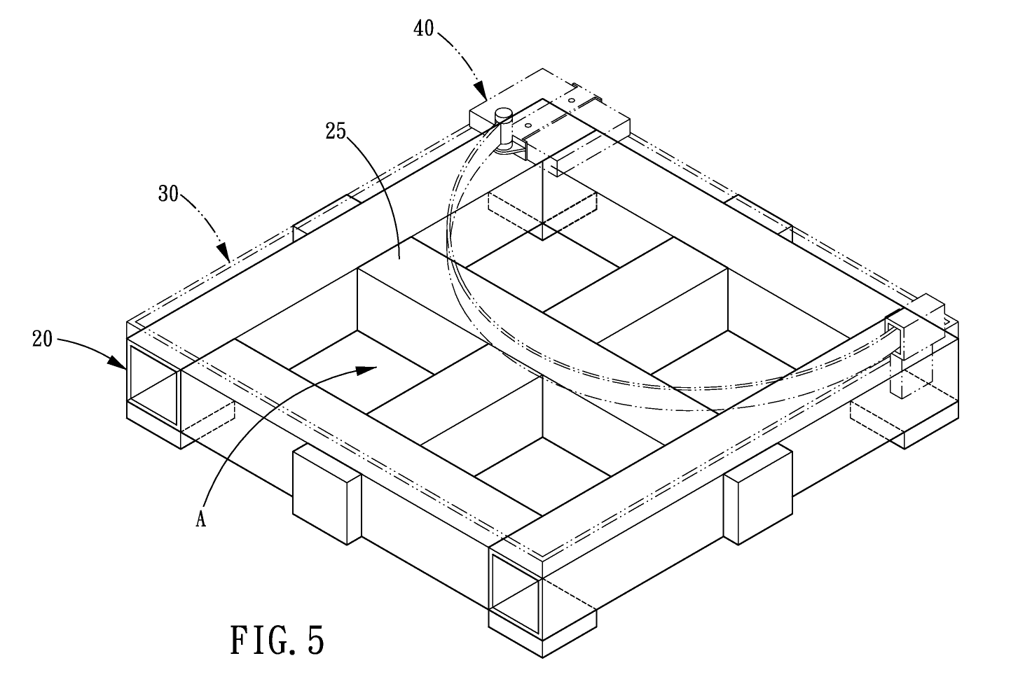

The base 20 of the present invention is not limited to the above-mentioned three assembly methods and materials. When the size of the base 20 is bigger, a plurality of reinforced pipes can be provided in the base 20, for example, two reinforced pipes 25 which are vertical to each other are provided in the hollow space A as shown in FIG. 5, so that the hollow space A is divided into four portions, so as to increase the rigidity of the base 20. Certainly, the reinforced pipes 25 are not limited to the vertical arrangement, other arrangements can also be used as along as they can increase the intensity of the base 20. Since the base 20 is made of metal, and the panel 30 is made of metal plate material with low carbon content, the base 20 and the panel 30 can be welded together. In addition, during the manufacturing of the base 20, the working surface 21, the jointing surface 22 and the lateral surfaces 23 are connected to one another by welding, and in the same welding procedure, the base 20 can be welded to the panel 30 stably. By such arrangements, the weight of the base 20 can be largely reduced, and the cost of the base 20 can also be reduced.

Since the weight of the base 20 is reduced, when the planar servo motor is hung upside down, the base 20 can be prevented from being deformed by its own weight, and the load of the machine table for supporting the base 20 can be relatively reduced, so as to avoid causing vibration and influencing the processing precision. Since the base 20 is not solid but hollow, and if it is fixed to the machine table simply by threaded members, the base 20 is probably not strong enough to provide the fixing force and will be damaged. Therefore, the assembly portions 24 are provided on the base 20 for allowing the threaded members to be inserted therethrough and threaded on the machine table, so that the locking force supported by the base 20 is partially shared by the assembly portions 24, so as to prevent the base 20 from being damaged and ensure it can be stably threaded on the machine table.

While we have shown and described various embodiments in accordance with the present invention, it should be clear to those skilled in the art that further embodiments may be made without departing from the scope of the present invention.

What is claimed is:

1. A base for planar servo motor, one surface of the base being connected to a panel, a mover being movable with respect to the panel, wherein:
the base comprises a plurality of lateral surfaces which define a hollow space, and the panel is located on top edges of the lateral surfaces.

2. The base for planar servo motor as claimed in claim 1 further comprising a working surface and a jointing surface and being closed in cross section, the working surface and the jointing surface being connected to the lateral surfaces, and the panel being welded to the working surface of the base.

3. The base for planar servo motor as claimed in claim 1 further comprising a jointing surface and being U-shaped in cross section, the lateral surfaces being connected to a periphery of the jointing surface, and the panel being located on the top edges of the lateral surfaces and adjacent to the hollow space.

4. The base for planar servo motor as claimed in claim 1, wherein the lateral surfaces are selected from the group consisting of plates and pipes.

5. The base for planar servo motor as claimed in claim 1, wherein the base is made of metal.

6. The base for planar servo motor as claimed in claim 1, wherein a plurality of reinforced pipes is provided in the hollow space of the base.

7. The base for planar servo motor as claimed in claim 1, wherein the panel is made of plate material with low carbon content and is welded to the base.

8. The base for planar servo motor as claimed in claim 1, wherein a plurality of assembly portions is provided on the lateral surfaces of the base.
